(19) United States
(12) Patent Application Publication
(10) Pub. No.: US 2011/0201126 A1
(43) Pub. Date: Aug. 18, 2011

(54) INTERFACE TO A MASS SPECTROMETER

(76) Inventor: Graham John HUGHES, Oakville (CA)

(21) Appl. No.: 12/707,119

(22) Filed: Feb. 17, 2010

(51) Int. Cl. G01N 1/22; B01J 8/00; G05D 7/00; B23P 11/00

(52) U.S. Cl. 436/175; 422/83; 29/428; 422/500; 422/544

(57) ABSTRACT

An interface is provided for coupling a sample source, including a TOC/TN analyzer to an isotope detector, including an isotope ratio mass spectrometer. The interface comprises a sample conduit having an inlet for fluid connection with the sample source and an outlet for fluid connection with the isotope detector. A sample trap is fluidly connected in the sample conduit. A helium bypass conduit is has an inlet for fluid connection with a helium supply line and an outlet for fluid connection with the sample conduit. The interface traps the target sample while contaminants are exhausted. The sample is released from the sample trap and is carried to the isotope detector on a stream of helium. Effluent contaminants are not held in the interface. There is no significant fouling of the interface or contamination of samples carried to the isotope detector.

### FIELD OF THE INVENTION

The present invention generally relates to an interface used for coupling a total organic carbon (TOC) and/or total nitrogen (TN) analyzer to a mass spectrometer or other stable isotope analyzer. More particularly, the present invention concerns a vented interface that can be used to deliver to a mass spectrometer samples generated or contained in a flow which is incompatible with the helium carrier required by the mass spectrometer.

### BACKGROUND OF THE INVENTION

Total organic carbon (TOC) is a measure of the amount of carbon that is bound in organic compounds. Frequently a determination of the TOC is used as an analytical indicator of water quality. The TOC present in a water sample is a result of the decaying natural organic material (i.e. humic acid, fulvic acid), and/or synthetic organic compounds such as detergents, pesticides, fertilizers and industrial chemicals. Typically the TOC is calculated by measuring the total amount of carbon present in a water sample, determining the total quantity of inorganic carbon present, and subtracting the inorganic carbon from the total carbon. Another method of TOC calculation is conducted by acidification of the sample to evolve carbon dioxide, measuring it as inorganic carbon, the oxidizing and measuring the remaining organic carbon in the sample. A third method involves directly measuring the TOC by acidifying the entire sample, purging the inorganic carbon as CO₂ to the air, then oxidizing the remaining contents producing a gas, which is then sent to a detector for measurement. The oxidation step can be performed by TOC analyzers by one of the following processes: high temperature combustion, high temperature catalytic oxidation, photo-oxidation (UV light), thermochemical (persulfate) oxidation, photochemical oxidation, or electrolytic oxidation.

An isotope ratio mass spectrometer (IRMS) or a laser excitation stable isotope analyzer coupled with a TOC analyzer can be used to determine total carbon mass and the ratio of stable isotopes of carbon contained within the TOC. Such information can provide useful insight into the source of the organic carbon contamination, carbon cycling and other environmental factors.

Similarly an analysis of total Nitrogen (TN) in water samples can provide information which is useful in the study of soil, water, and wastewater systems.

Samples must be introduced to the IRMS as pure gases achieved through combustion, chemical trapping or gas chromatographic feeds. It is critical that a sample be processed before entering the mass spectrometer so that only a single chemical species enters at a given time. By comparing detected isotope ratios against known standards, an accurate determination of the isotopic makeup of a sample can be obtained. Most isotope ratio mass spectrometer is continuous flow, meaning that at a pure stream of helium, such as helium flows through the IRMS at all times. A gas sample to be analyzed is prepared immediately before introduction to the IRMS. The gas sample is carried into the IRMS on the stream of helium carrier gas and the sample is measured once. The known standard gasses may be measured before and after the sample.

TOC analyzers wherein the oxidation step is performed by one of the following processes: high temperature combustion, high temperature catalytic oxidation, photo-oxidation (UV light), thermochemical (persulfate) oxidation, photochemical oxidation, or electrolytic oxidation, have not been readily able to be coupled to IRMS instrumentation, even in connection with samples derived from fresh water, since the output of TOC analyzers of these types is incompatible for inputting to IRMS. The oxidation step in all of these processes will result in a sample output which is contaminated with O₂ or air, and such outputs are incompatible with stable isotope analysis of samples which must be conducted using a helium carrier.

Although a thermo chemical TOC analyzer can readily be coupled to an IRMS to measure dissolved organic carbon in freshwater samples, analytical limitations have precluded the use such equipment to analyze saline water samples. Saline water contains large quantities of dissolved salts, particularly NaCl. Even after acidification and oxidation, samples originating from saline water retain halide ion contamination. Halide ion contamination will damage the IRMS, possibly destroying the filament. Accordingly, it is necessary to flush halide ions out of the sample prior to entry to the IRMS.

Attempts have been made to couple a high temperature catalytic oxidation TOC analyzer to an IRMS to detect the isotope composition of dissolved organic carbon.

As discussed in “The Use Of Wet Chemical Oxidation With High Amplification Isotope Ratio Mass Spectrometry (Co-IRMS) To Measure Stable Isotope Values Of Dissolved Carbon In Seawater”, (Osburn and St-Jean, Limnology and Oceanography: Methods, 2007, pp. 296-308), following oxidation of a marine water sample, the sample flow was directed through halogen scrubbers and chemical reductants prior to entry to the mass analyzer. Adjustments were made to the wet oxidation system and to the IRMS sensitivity. A copper shot trap was placed in the flow path between the TOC analyzer and the IRMS. The copper shot trap absorbed Cl₂ gas and chloride in aerosols forming copper chloride, copper oxide and/copper sulfate. Eventually the spent copper needed to be replaced. Moreover, salt and moisture collected at the bottom of the trap causing a buildup which restricted flow through the trap. Only limited success was realized since the halide gases produced salt deposits in the flow lines of the system, caused corrosion in the reaction vessel, fouling of the halide trap, and rapid exhaustion of the reduction agents.

Panetta, Ibrahim, and Gelinas have reported a study of “Coupling a High-Temperature Catalytic Oxidation Total Organic Carbon Analyzer to an Isotope Ratio Mass Spectrometer to Measure Natural-Abundance δ¹³C-Dissolved Organic Carbon in Marine and Freshwater Samples”, (Analytical Chemistry Jul. 1, 2008, 80, No 13, pp. 5232-5239). Combustion gases from a TOC were directed through a copper cooling tube, a pure water trap (to trap volatile inorganics), a DIC reduction vessel, a dehumidifier, a copper wool halogen trap and an aerosol filter before spectrophotometric detection of CO₂. A cupric oxide/quartz catalyst was used in the combustion chamber of the TOC. This catalyst acted as an oxidant as well as a catalyst. A three-way valve was installed to allow the user to switch between air and He as a carrier gas, depending on whether the instrument was used for TOC analysis or for TOC-IRMS analysis. The carrier gas was switched from helium to air overnight to aid in regeneration of cupric oxide. A series of valves was provided in the trapping loop and valve system to enable switching of the flow path from the TOC to the elemental analyzer system without simultaneous overlap, a situation which would cause overpressure in the TOC and a loss of flow to the IRMS, resulting in the introduction of ambient air to the ion source of the IRMS. A layer of cobaltous silver oxide placed at the beginning of the copper reduction column acted as a third halogen trap.

The foregoing system for coupling a TOC analyzer to an IRMS to measure δ¹³C-dissolved organic carbon in marine and freshwater samples has a number of drawbacks. This prior system removes moisture and chlorine, but there is no teaching of removal of NO, SO2 or any other gas typically present after digestion of a water sample in a TOC analyzer. The interface requires the use of a cold finger, or liquid nitrogen trap for trapping the CO₂. The liquid nitrogen trap will not only trap CO_{2,} it will trap everything carried on the stream. It is then necessary to incorporate a gas chromatograph column at the end of the liquid nitrogen trap to separate the gases before they are sent to the mass spectrometer. The resulting IRMS readings will reflect numerous “background noise” peaks limiting the quality of the resulting data. Additionally, the prior system uses an injection loop for introduction of a sample, to permit the use of one three way valve. Unfortunately, the use a three way valve can cause backpressure, potentially causing the TOC analyzer to leak. Moreover, the use of an injection loop results in loss of a portion of the test sample in order to fill the loop, and only a portion of the sample would reach the IRMS. In order to compensate for sample loss, larger working samples are required.

The known systems are complex, involving the interconnection of numerous material handling steps and techniques. Equipment costs for existing systems may become prohibitive, particularly of equipment such as cryogenic furnaces must be implemented.

There is a need for an interface coupling a TOC and/or TN analyzer to a mass spectrometer which illuminates the need for multiple halogen scrubbers, to facilitate sampling from sources such as saline water, which releases halide ions during TOC and/or TN analysis.

There is a need for an interface which eliminates incompatibility between TOC/TN analyzers (other than thermo chemical analyzers) and stable isotope analyzers.

Further, there is a need for an interface which is not expensive to construct, is easy to automate, and can be readily customized. Preferably the interface would introduce samples directly into a mass spectrometer without the need for injection loops or GC columns.

There is a need for an interface that will facilitate rapid and economical testing runs.

There is a need for an interface for a sequential TOC and mass spectrometer that regulates the flow to the mass spectrometer without creating excessive back pressure, so as to protect the sensitive and fragile assemblies in the TOC and the mass spectrometer.

### SUMMARY OF THE INVENTION

In accordance with the present invention, an interface is provided for coupling a TOC/TN analyzer to a mass spectrometer. The interface comprises a sample conduit having an inlet for fluid connection with a TOC/TN analyzer; and an outlet for fluid connection with a mass spectrometer. A sample trap is fluidly connected in the sample conduit. A first sample flow controller is provided in fluid connection in the sample conduit between the TOC/TN analyzer and the sample trap. The flow controller is selectively positionable between an open position permitting a sample flow into the sample trap while blocking the sample flow to a release vent, and a closed position blocking an effluent flow to the sample trap, while permitting the effluent flow to the release vent. A second sample flow controller is provided in fluid connection in the sample conduit between the sample trap and the mass spectrometer. The second sample flow controller is selectively positionable between a closed position blocking sample flow to the mass spectrometer while permitting effluent flow to an exhaust vent, and an open position permitting sample flow to the mass spectrometer, while blocking effluent flow to the exhaust vent. A helium bypass conduit is provided. The helium bypass conduit has an inlet for fluid connection with a helium supply line and an outlet for fluid connection with the sample conduit at a position downstream of the second sample flow controller. A first bypass flow controller is in fluid connection between the helium bypass conduit and the sample conduit at a position downstream of the second sample flow controller. The first bypass flow controller is selectively positionable between an open position permitting helium flow into the sample conduit, while blocking helium flow to a first helium vent, and a closed position blocking helium flow into the sample conduit, while permitting helium flow to the first helium vent. A second bypass flow controller is in fluid connection between the helium bypass conduit and the sample conduit at a position upstream of the sample trap. The second bypass flow controller is selectively positionable between an open position permitting helium flow to the sample conduit, while blocking helium flow to a second helium flow vent, and a closed position blocking helium flow the sample conduit, while permitting helium flow to the second helium vent. An electromechanical means is provided for operating the first and second sample flow controllers and the first and second bypass flow controllers through a software program executed by computer means.

In accordance with another embodiment of the present invention an interface to an isotope detector comprises a sample conduit having an inlet for fluid connection with a sample source, and an outlet for fluid connection with the isotope detector. A sample trap is fluidly connected in the sample conduit. A first sample flow controller is fluidly connected in the sample conduit between the sample source and the sample trap. The flow controller is selectively positionable between an open position permitting a sample flow into the sample trap while blocking the sample flow to a release vent, and a closed position blocking an effluent flow to the sample trap, while permitting the effluent flow to the release vent. A second sample flow controller is in fluid connection in the sample conduit between the sample trap and the isotope detector. The second sample flow controller is selectively positionable between a closed position blocking sample flow to the isotope detector while permitting effluent flow to an exhaust vent, and an open position permitting sample flow to the isotope detector, while blocking effluent flow to the exhaust vent. A helium bypass conduit is provided, having an inlet for fluid connection with a helium supply line and an outlet for fluid connection with the sample conduit at a position downstream of the second sample flow controller. A first bypass flow controller is in fluid connection between the helium bypass conduit and the sample conduit at a position downstream of the second sample flow controller. The first bypass flow controller is selectively positionable between an open position permitting helium flow into the sample conduit, while blocking helium flow to a first helium vent and a closed position blocking helium flow into the sample conduit, while permitting helium flow to the first helium vent. A second bypass flow controller is in fluid connection between the helium bypass conduit and the sample conduit at a position upstream of the sample trap. The second bypass flow controller is selectively positionable between an open position permitting helium flow to the sample conduit, while blocking helium flow to a second helium flow vent, and a closed position blocking helium flow the sample conduit, while permitting helium flow to the second helium vent. An electromechanical means is provided for operating the first and second sample flow controllers and the first and second bypass flow controllers through a software program executed by computer means.

In accordance with the present invention, there is provided a method of conveying a sample to an isotope detector for analysis. The method comprises the steps of (a) collecting effluent containing the sample in a sample conduit containing a sample trap; (b) trapping the sample within a sample trap; (c) exhausting the remaining effluent; and, (d) releasing the sample from the sample trap into a helium stream flowing to the isotope detector. The method may further comprise the step of flushing the sample trap with helium prior to step (d).

### BRIEF DESCRIPTION OF THE DRAWINGS

FIG. 1 is a schematic illustration of an interface for coupling a TOC analyzer to a mass spectrometer shown in a standby state;

FIG. 2 is a schematic illustration of the interface of FIG. 1 in a TOC digestion and CO₂ trapping state;

FIG. 3 is a schematic illustration of the interface of FIG. 1 in a He flushing state; and,

FIG. 4 is a schematic illustration of the interface of FIG. 1 in a spectrometer loading state.

FIG. 5 is a schematic illustration of another embodiment of the present invention, providing an interface for introducing a sample to an isotope detector, shown in a standby state.

### DETAILED DESCRIPTION OF PREFERRED EMBODIMENTS

The interface according to the present invention can be used to couple analyzers and detectors in many applications. In fact, the interface has application in any system where a person must trap a sample produced in one gas environment and then elute the sample for detection in a different gas environment. For example, the interface can be employed for trapping and concentrating CO₂ content from an air sample, and then conducting isotope detection by IRMS, wherein the CO₂ sample must be carried on a helium carrier stream. The interface can be used for coupling a combustion chamber to trap samples from NOx analysis for isotope detection by IRMS. The interface according to the present invention can be used to interface TOC analyzers which operate by any of the following processes: high temperature combustion, high temperature catalytic oxidation, photo-oxidation (UV light), thermochemical (persulfate) oxidation, photochemical oxidation, or electrolytic oxidation. The interface can be used with TN analyzers.

The interface of the present invention eliminates the need to match flow rates between coupled analyzers and isotope detectors. The interface is applicable isotope ratio mass spectrometers (IRMS) and to laser excitation stable isotope analyzers. Reference to “isotope detectors” as used in the present description and claims should be understood to include IRMS and laser excitation stable isotope analyzers.

The following description of the preferred embodiment of the invention focuses on the interface as used in connection with an IRMS. IRMS instrumentation is well known, and the sourcing and selection of particular instruments is within the capability of someone skilled in the art. In order for an IRMS to read the carbon isotope of hydrocarbons or the nitrogen isotopes from chemically bound nitrogen in a water sample, it must be presented to the IRMS in a form that can be detected. Specifically, the sample must be in gaseous form and it must be chemically pure or as pure as possible so as not to get matrix or background effects. The CO₂ or NO produced by the TOC/TN analyzer reducing the hydrocarbons or chemically bound nitrogens is of a suitable form for measurement by IRMS.

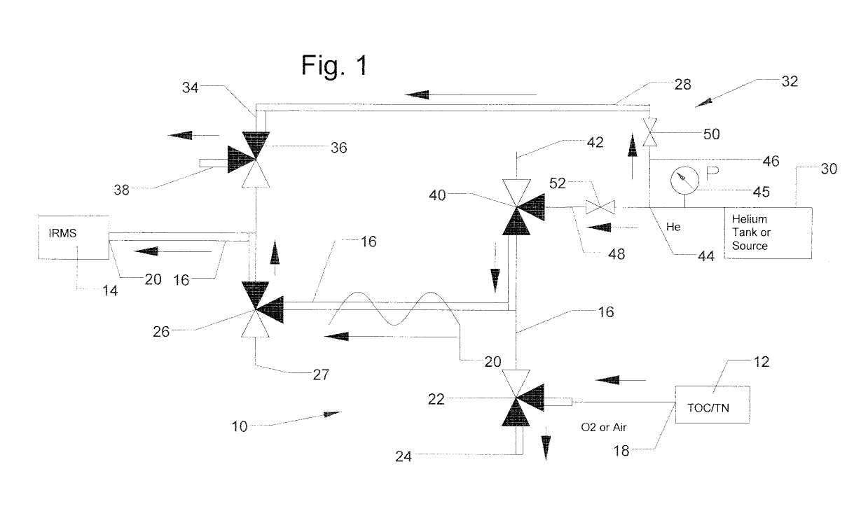

Referring now to FIGS. 1-4, an interface, shown generally by reference numeral 10, is provided for coupling a total organic carbon/total nitrogen (TOC/TN) analyzer 12 to a mass spectrometer 14. In a preferred embodiment, this interface is contemplated for use with an Isotope Ratio Mass Spectrometer (IRMS) 14 and a total organic carbon/total nitrogen analyzer 12.

The interface 10 has a sample conduit 16 with an inlet 18 for fluid connection with the TOC/TN analyzer 12 and an outlet 20 for fluid connection with a mass spectrometer 14.

TOC analyzers, TN analyzers, and TOC/TN analyzers are well known in the analytical chemistry industry and persons skilled in the art can readily select and source an applicable analyzer to meet their needs. The interface of the present invention is compatible with all such instruments. The term “TOC/TN” as used in the description and claims is intended as a shorthand manner of referencing either a TOC analyzer, or a TN analyzer, or an analyzer which has capability to detect either or both TOC and TN. By way of example only, and for ease of illustration, reference is made to the TOCN-4110 On-line TOC/TN Analyzer available from Shimadzu Corporation. The TOCN-4110 is a compact, unique water quality analyzer allowing both TOC analysis by the combustion oxidation/infrared detection method, and TN analysis by the combustion/chemiluminescence detection method, all in a single unit. a TOC/TN analyzer 12 supplies a constant stream of carrier gas into the sample conduit 16. When the TOC/TN analyzer 12 is in processing or standby modes the carrier gas is typically air or an oxygen (O₂) rich mixture. When the TOC/TN analyzer releases a processed sample, it will contain the digested test sample, typically a mix of CO₂, being the product of oxidation reaction carried out on the test sample, together with carrier gas, and possibly other reaction products. If a determination of total nitrogen is being undertaken, NO will be released from the TOC/TN analyzer together with the carrier gas. When a saline water sample has been digested, the sample will contain considerable quantities of contamination from the dissolved salts in the saline water. The effluent will contain halide ions, most often Cl⁻, in the form of Cl₂, but other halogens may also be present, at lower concentrations.

A sample trap 20 is fluidly connected in the sample conduit 16. The present invention contemplates the use of either one sample trap, or multiple (2 or more) sample traps fluidly connected in series. For ease of illustration, only a single sample trap 20 is schematically represented in the figures. The selection of trapping material is dependent upon whether CO₂ or NO is desired to be trapped. In the event that testing is being performed to collect both TOC and TN data, both CO₂ and NO may be trapped. In such instance, the interface will have two sample traps 20 in series, one for trapping CO₂ one and the other for trapping NO. Each sample trap 20 will only trap and hold either CO2 or NO (depending upon which trapping material is loaded in a given sample trap) leaving the other gases in the effluent from the TOC/TN analyzer, that could be deleterious to the detector 14, to be flushed through the sample conduit 16 and out to exhaust vent 27.

It is known to trap CO₂ on fine grade silica gels or amine surface bonded silica gels. CO₂ Trapping materials which are made from the naturally occurring mineral gypsum (Calcium Sulfate) are available from W.A. Hammond Drierite Co. Ltd under the trade-mark DRIERITE. Molecular sieve products constructed from alkali metal aluminosilicates in spherical form can also be used as trapping material for CO₂. Molecular sieves having the formula: Ca4,5 [(Al02)12(SiO2)12].nH2O are available from Interra Global Corp. Zeolitic imidazolate frameworks are metal-organic framework CO₂sinks which could also be adapted for use as trapping materials. A material for trapping CO₂ in accordance with the present invention may be selected from the foregoing group of trapping materials. In the particular example of a preferred embodiment of the present invention described herein, silica gel is used as the CO₂ trapping material.

Likewise, there are known materials for the trapping of NO. One such example is the naturally occurring mineral gypsum (Calcium Sulfate) is available from W.A. Hammond Drierite Co. Ltd under the trademark DRIERITE. Selection of a particular material for trapping NO is a routine matter within the capability of one skilled in the art.

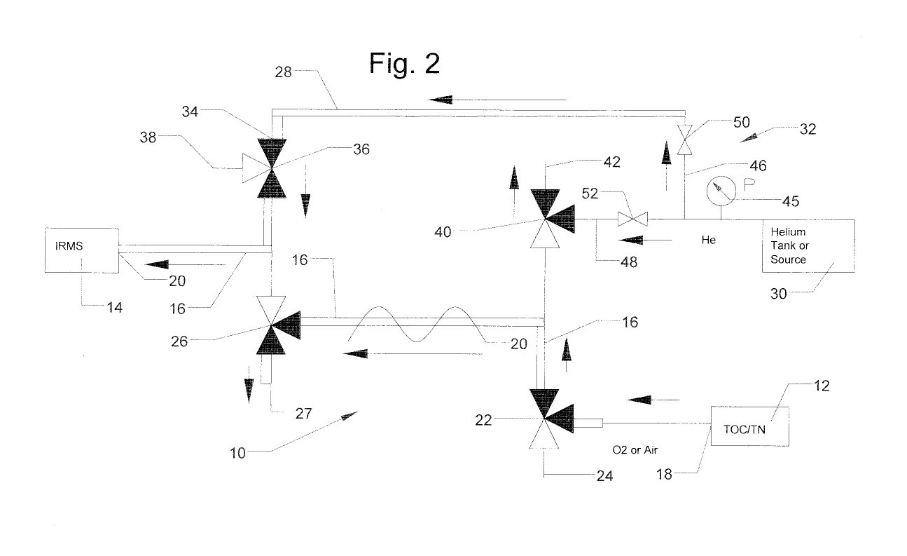

A first sample flow controller 22 is connected in fluid connection in the sample conduit 16 between the TOC/TN analyzer 12 and the sample trap 20. The flow controller 22 is selectively positionable between an open position permitting a sample flow into the sample trap 20 (as shown in FIG. 2) while blocking the sample flow to a release vent 24, and a closed position blocking an effluent flow to the sample trap 20, while permitting the effluent flow to the release vent 24 (as shown in FIGS. 1, 3, and 4).

Reference is made to flow controllers in the description of the present invention. The particular type of flow controller to be used is not critical to carrying out the invention, so long as the flow controllers have adequate capacity, are capable of directing fluid flow as discussed herein, and can be operated by electromotive force under computer control. The selection of particular flow controllers is within the capability of a person skilled in the art.

The flow controllers used in the preferred embodiment of the present invention, are three-way 15 VDC or 24 VDC valves.

It should be noted that each of the flow controllers are connected in conjunction with vents. The vents are present in the interface 10 according to the present invention in order to prevent pressure spikes when operating the valves. Both the TOC/TN and the IRMS require a constant flow to operate efficiently. Changing flows caused by whatever reason may cause the detectors in the TOC/TN or the IRMS to misread analytes or fail to register them altogether, thus potentially corrupting the resultant data. Moreover, in some instances pressure spikes could cause long term damage to the instrumentation in the TOC/TN or the IRMS.

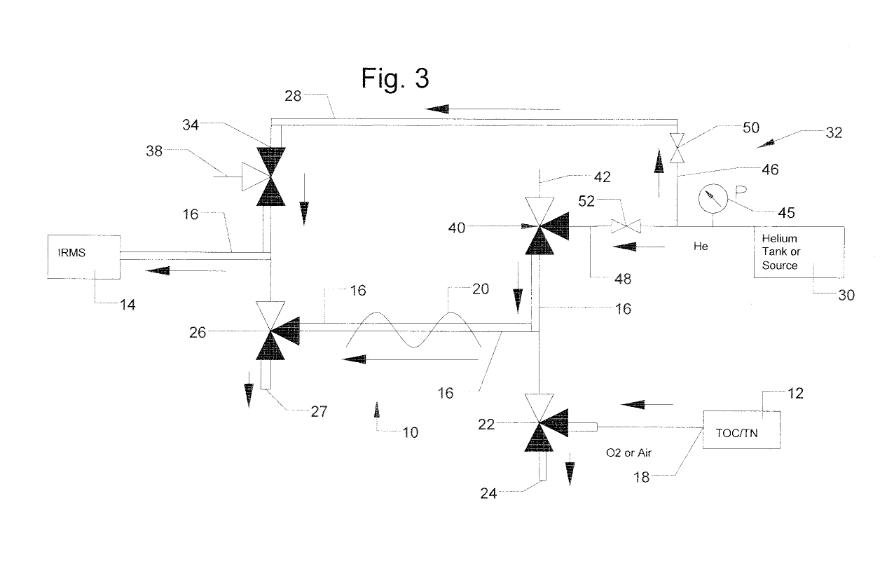

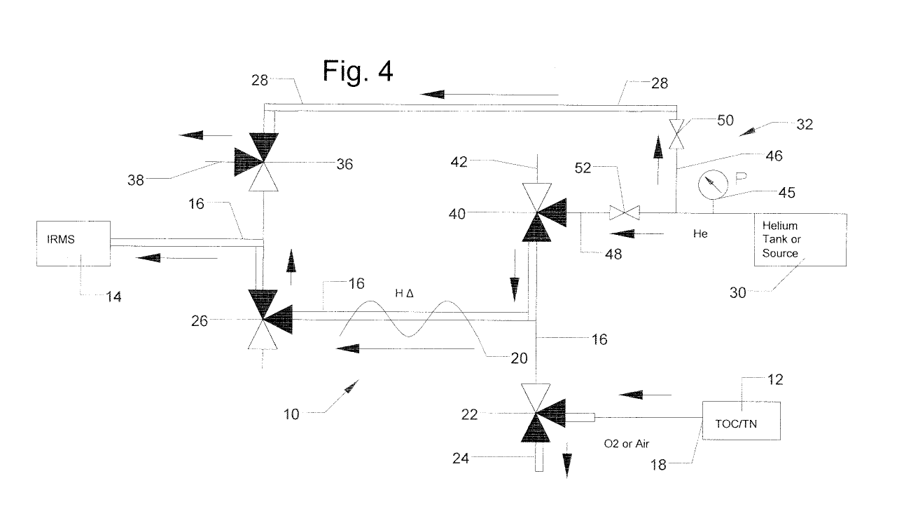

A second sample flow controller 26 is in fluid connection in the sample conduit 16 between the sample trap 20 and the mass spectrometer 14. The second sample flow controller 26 is selectively positionable between a closed position blocking sample flow to the mass spectrometer while permitting effluent flow to an exhaust vent 27 (as shown in FIGS. 2 and 3), and a open position permitting sample flow to the mass spectrometer, while blocking effluent flow to the exhaust vent (as shown in FIGS. 1 and 4).

A helium bypass conduit 28 is provided. The helium bypass conduit 28 has an inlet, shown by the general reference numeral 32, for fluid connection with a helium supply line and an outlet 34 for fluid connection with the sample conduit 16 at a position downstream of the second sample flow controller 26. The helium source 30 is preferably a helium (He) tank or source. The helium supply line is preferably constructed with a splitter 44 in fluid connection with a first branch 46 for the provision of helium to the first bypass flow controller 28 and a second branch 48 for provision of helium to the second bypass flow controller 40. Each branch 46, 48 is equipped with a flow meter 50, 52 to maintain the same flow of helium through each branch. Preferably the flow meters are rotameters. A pressure gauge 54 is installed upstream of the splitter 44 in the helium conduit If it samples 28. It is preferred to use a pressure gauge 45 capable of maintaining the interface at pressures not significantly exceeding 50 psi.

The materials selection for the sample conduit 16 and the bypass conduit 28 are not critical to the operation of the interface of the present invention. In the preferred embodiment of the present invention, copper tubing is used because it is inert (for the purposes of the reactions carried in the present interface system), is air tight, and is easy to bend into optimal shape. Typically a tubing diameter of approximately ⅛″ ID would be acceptable, but this can be varied as needed. Polytetrafluoroethylene (PTFE) hose might be somewhat suited for the conduits, though it is not optimal, since this material may leak air into the flow and it is a poor conductor of heat, Glass would be an acceptable conduit material, as it is inert and conducts heat. The fluid pressures in the system would not prevent the use of glass. Nevertheless, glass is subject to breakage. It is within the capability of a person skilled in the art to conduct routine testing and select an appropriate conduit material.

A first bypass flow controller 36 is in fluid connection between the helium bypass conduit 28 and the sample conduit 16 at a position downstream of the second sample flow controller 22. The first bypass flow controller 36 is selectively positionable between an open position permitting helium flow into the sample conduit (as shown in FIGS. 2 and 3), while blocking helium flow to a first helium vent 38, and a closed position blocking helium flow into the sample conduit 16, while permitting helium flow to the first helium vent 38.

A second bypass flow controller 40 is in fluid connection between the helium bypass conduit 28 and the sample conduit 16 at a position upstream of the sample trap 20. The second bypass flow controller 40 is selectively positionable between an open position permitting helium flow to the sample conduit (as shown in FIGS. 1,3 and 4), while blocking helium flow to a second helium flow vent 42, and a closed position blocking helium flow the sample conduit 16, while permitting helium flow to the second helium vent 42.

Electromechanical means (not shown) are used for operating the first and second sample flow controllers and the first and second bypass flow controllers. The electromechanically means are operated through a software program executed by computer means, to control the opening and closing of the respective flow controllers at the appropriate times and for appropriate intervals to carry out the steps of a sample processing cycle using the interface.

The timing is actually based on the TOC itself. The software or programmable timer will turn first sample flow controller 22 from the vent 24 to the open position allowing the sample to pass into the sample conduit 16 immediately when the TOC/TN has injected the sample into the reaction chamber/combustion tube with the software or programmable timer being externally started by the IRMS or TOC/TN from their external output event timer in their operating software. The length of time for this step will based on the type of reaction (UV/Persulfate, combustion etc), the dead volume from the injection port of the TOC/TN to the chemical trap in the interface, and the flow rate of the vent gas which is controlled by the TOC/TN analyzer. The rest of the timing is done by control of the interface software. The venting time for the removal of the Air/O2 from the trap by flushing with helium will be within the range of 20-50 seconds. The heating of the trap and changing flow to the IRMS from the trap takes about 2-4 minutes but is dependent on flow rate of the helium, which in turn is dependent on whether the IRMS is setup to accept low flows such as a Gas Chromatograph flow (approx 3.0 mls per minute) or higher flows from more concentrated materials such as elemental analyzer injections (approx 30 mls per minute). Once all of the sample is released is goes back to the standby state.

In essence the interface of the present invention operates in the opposite manner to previous interfaces for coupling TOC/TN analyzers with IRMS for measurement of isotopes in water samples, and in particular saline samples. As detailed above, the prior art interfaces employ multiple traps and scrubbers to attempt to remove halide ions, O₂, and air, and possibly other contaminants from the sample CO₂ or NO containing effluent released from the TOC/TN analyzer. The contaminants are trapped within the scrubbers inside interface, rapidly causing fouling of the lines and traps. Incomplete cleaning of the sample flow can result, with the potential for inaccurate IRMS readings and even damage to the IRMS instrumentation.

The present invention does not attempt to trap contaminants in the sample flow. Instead, the present invention traps the sample target, i.e. the CO₂ or NO contained in the effluent released from the TOC/TN analyzer, and holds it temporarily while all remaining contaminants are flushed away by a helium stream. Once flushed, the sample is released from the sample traps and carried to the IRMS on a stream of pure helium. The contaminants are never held in the interface, there is no significant fouling of the interface or contamination of samples carried to the IRMS.

The operation of the interface of the present invention will now be explained with reference to FIGS. 1-4 in sequence.

FIG. 1 shows the standby state of the interface 10. The first sample flow controller 22 is in the closed position, preventing flow through the sample line. The effluent from the TOC/TN analyzer is being vented outside through vent 24. At this stage, the effluent is an air or O₂ steam integral to the operation of the TOC/TN analyzer. If O₂ does not continuously stream past the quartz combustion tube (containing catalyst) which is inside the TOC/TN analyzer, the catalyst degrades quickly and may not completely digest the hydrocarbons to CO2 or the chemically bound nitrogens to NO defeating the Total in TOC/TN. During the standby stage, it is necessary to divert to the effluent to the vent 24, so as to prevent pressure back up in the TOC/TN analyzer. A significant backpressure (>50 psi) could damage the IR detector in the TOC/TN, blow the quartz combustion tube, or otherwise damage the inner workings. The interface according to the present invention has the TOC/TN effluent gases flowing to vent as a standby position so that if the power is removed there is no pressure buildup. Concurrently, in the standby stage, the second bypass controller 40 is also in the open position allowing helium flow from the second branch 48 to flow into the sample conduit 16, flushing pure helium through the sample trap 20. The second sample flow controller 26 is also in the open position, allowing the Helium to flow through to the mass spectrometer. In the standby state, the mass spectrometer requires a constant flow of helium. No measurements are being made or data collected at this time by either the TOC/TN 12 or the detector 14. The bypass helium continues to flow through the first branch 46 of the inlet 32 and the bypass conduit 28 to flow to vent 38.

FIG. 2 shows the interface 10 when the TOC/TN analyzer 12 is running a digestion, and the CO₂ and/or NO sample containing effluent is being emitted through the outgas vent of the TOC/TN analyzer to the interface and then through the sample trap 20 at ambient temperature. The first flow controller 22 is switched to the open position allowing the flow of effluent carrying the CO₂ and/or NO sample to be collected into the sample conduit 16 and flow into the sample trap 20. The step of collecting effluent containing the sample in the sample conduit occurs at this stage. As the effluent comes into contact with the trapping material, the step of trapping the sample occurs. Dependent upon whether CO₂ or NO is being trapped in a particular instance, the appropriate trapping material will trap the CO₂ or NO sample. The step of exhausting the effluent follows. The CO₂ or NO sample (as applicable) remains in the sample trap, leaving the other gases that could be deleterious to the detector 14 to be carried onward through the sample conduit 16. The second sample flow controller 26 has been switched to in the closed position, blocking access to the IRMS 14, but permitting the deleterious gasses to flow out the exhaust vent 27, thereby venting the effluent. Concurrently, helium is flowing through the bypass conduit 28, and the first bypass controller 36 has been switched to the open position, allowing the helium to flow into the sample conduit 16 so as to be flushed through the IRMS 14. A lack of flow to the IRMS would damage its instrumentation, so a constant flow is necessary.

FIG. 3 shows the sample conduit 16 and sample trap 20 again being flushed by helium. During the helium flush, the first sample flow controller 22 switched to the closed position, preventing the air or O2 flow from entering the sample conduit 26, and instead releasing it to the vent 24. The first bypass flow controller remains in the open position allowing the protective flow of helium to continue to flow into the sample conduit 16 and through the IRMS. The second bypass controller 40 is switched to the open position, allowing helium to flow from the helium source into the sample conduit and the sample trap 20. The second flow sample controller remains closed, directing the helium flush to be vented outside through exhaust vent 27. This step is conducted at ambient temperature. During the helium flush, the first bypass flow controller is in the open position allowing bypass helium line to maintain flow to the IRMS 14. TOC/TN analyzer is in standby mode, and continues to emit air or O2, which is vented to vent 24.

FIG. 4 shows the step of releasing the sample into the helium flow through the sample trap 20 and sending the flow directly to the IRMS 14. The second bypass flow controller 40 is open, permitting helium to flow into the sample conduit 16 and through the sample trap 20. A heating means (not shown structurally, but indicated by the symbol HΔ in FIG. 4) may be provided to heat the sample trap 20 in order to provide the required temperature increase to release the trapped gas sample component from the trapping material and re-dissolve it into the helium stream for measurement by the detector 14. The particular heating parameters will be dependent upon the selection of trapping material, and can be readily ascertained by a person skilled in the art. As the temperatures needed to release the trapped samples from the trap materials are typically low, on the order of 100° C. or 200° C., robust heating capability is not required. It is preferred to use a heated jacket around the trap tube with thermocouples for control. When multiple sample traps 20 are connected into the interface 10 in series, the use of a corresponding multiple number of heated jackets will allow for the heating of the sample traps sequentially, in order to release the multiple trapped species separately and carry them to the mass spectrometer sequentially. Other heating means may be used. For example, the sample conduit could be routed through a furnace for heating, but this alternative represents a higher equipment cost, requires AC power within the unit, and takes longer to cool to a standby state ready for the next sample.

In FIG. 4, the TOC/TN analyzer remains in standby mode, and continues to emit air or O₂, which is vented to vent 24. The first bypass flow controller switched to the closed position, preventing helium flow from the bypass conduit into 28 sample conduit 16. Instead, the helium flow from the bypass conduit 28 is vented through vent 38. This flow pattern through the bypass conduit and sample conduit in FIG. 4 is the same as the flow pattern in FIG. 1. The difference between the two figures is the indication that the sample trap is being heated in FIG. 4. to remove the target gas(es) from the sample trap for measurement in the IRMS.

Upon completion of the cycle, the interface 10 returns to the FIG. 1 standby state to await the testing of the next sample.

The interface 10 of the present invention facilitates the trapping of sample gas produced by a TOC or TOC/TN in any digestion or detection mode, including combustion, heated persulfate, UV/persulfate etc. The interface 10 further removes non-trapped species such as chlorine, air, O2, and then sends clean and concentrated carbon, nitrogen, or any other trapped sample species to the IRMS system for detection. All of the foregoing is completed with no loss of helium flow to the IRMS detector.

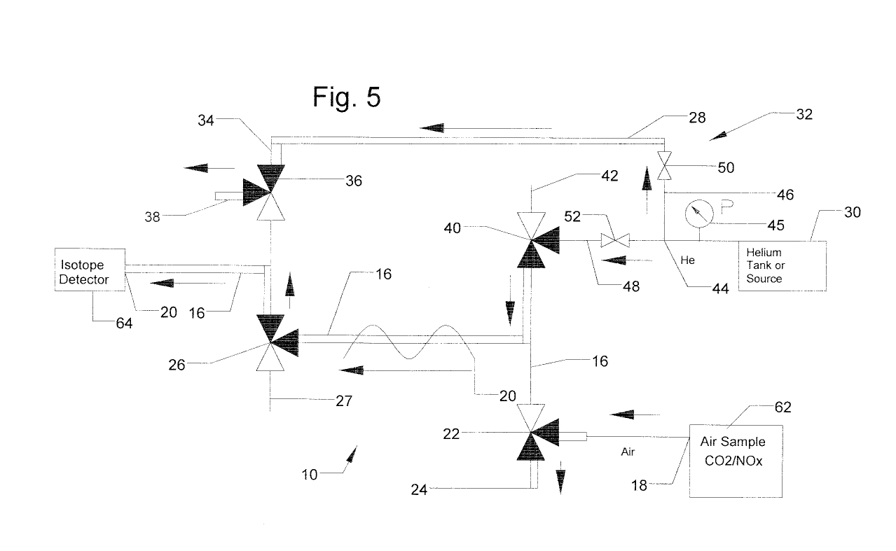

Turning now to FIG. 5 of the drawings, an interface to an isotope detector is provided in accordance with another embodiment of the invention. The only difference between FIG. 5 and FIG. 1 is the substitution of a sample source 62 in place of TOC/TN analyzer 12, and the substitution of isotope detector 64 in place of IRMS 14. The interface is applicable isotope ratio mass spectrometers (IRMS) and to laser excitation stable isotope analyzers. Reference to “isotope detectors” as used in the present description and claims should be understood to include IRMS and laser excitation stable isotope analyzers. The remaining structures are the same, and bear the same reference numerals as shown in the other figures. The interface 10 functions in the same manner as was described above in connection with the preferred embodiment of the invention, and the detailed description of the structure and function will not be repeated here. The differences between embodiments are discussed, as follows. Instead of coupling the interface to a vent line from a TOC/TN analyzer, the sample conduit 16 has an inlet 18 for fluid connection with a sample source 62.

The sample source 62 could be a sample bomb, which is a device used to suck a certain amount of air into an evacuated gas cylinder from a certain location. For carbon isotope measurement from CO₂ contained in an air sample, a sample pump (not shown) would then be employed to pump the air sample collected in the sample bomb through the inlet 18 into the sample conduit 16. The step of collecting effluent containing the sample in a sample conduit, would be accomplished by capturing an air sample with a sample bomb and pumping the sample into the inlet 18 of the sample conduit 16. The steps of trapping the sample within the sample trap, exhausting the remaining effluent, flushing the sample trap with helium, and releasing the sample from the sample trap into a helium stream flowing to the isotope detector, would then be conducted in the same manner as discussed above.

Alternatively, in the case of an analysis of bound nitrogen species, a furnace could be placed into the system following the sample bomb for the combustion of NOx and NH3 gases captured in the sample bomb. The effluent from the furnace would be collected (i.e. pumped) into the inlet 18 of the sample conduit 16 and the step of trapping the sample within the sample trap would be carried out using an NO trapping material as discussed above. The steps of exhausting the remaining effluent, flushing the sample trap with helium, and releasing the sample from the sample trap into a helium stream flowing to the isotope detector, would then be conducted in the same manner described in connection with the preferred embodiment of the present invention.

While there has been shown and described what are at present considered the preferred embodiments of the invention, it will be obvious to those skilled in the art that various changes and modifications can be made therein without departing from the scope of the invention defined by the appended claims.

I claim:

1. An interface for coupling a TOC/TN analyzer to a mass spectrometer comprising:
a. a sample conduit having an inlet for fluid connection with a TOC/TN analyzer; and an outlet for fluid connection with a mass spectrometer;
b. a sample trap fluidly connected in the sample conduit;
c. a first sample flow controller in fluid connection in the sample conduit between the TOC/TN analyzer and the sample trap, said flow controller being selectively positionable between an open position permitting a sample flow into the sample trap while blocking the sample flow to a release vent, and a closed position blocking an effluent flow to the sample trap, while permitting the effluent flow to the release vent;
d. a second sample flow controller in fluid connection in the sample conduit between the sample trap and the mass spectrometer, said controller being selectively positionable between a closed position blocking sample flow to the mass spectrometer while permitting effluent flow to an exhaust vent, and a open position permitting sample flow to the mass spectrometer, while blocking effluent flow to the exhaust vent;
e. an helium bypass conduit having an inlet for fluid connection with an helium supply line and an outlet for fluid connection with the sample conduit at a position downstream of the second sample flow controller;
f. a first bypass flow controller in fluid connection between the helium bypass conduit and the sample conduit at a position downstream of the second sample flow controller; said first bypass flow controller being selectively positionable between an open position permitting helium flow into the sample conduit, while blocking helium flow to a first helium vent, and a closed position blocking helium flow into the sample conduit, while permitting helium flow to the first helium vent; and,
g. a second bypass flow controller in fluid connection between the helium bypass conduit and the sample conduit at a position upstream of the sample trap, said second bypass flow controller being selectively positionable between an open position permitting helium flow to the sample conduit, while blocking helium flow to a second helium flow vent, and a closed position blocking helium flow the sample conduit, while permitting helium flow to the second helium vent.

2. The interface of claim 1, further comprising electromechanical means for operating the first and second sample flow controllers and the first and second bypass flow controllers, operated through a software program executed by computer means.

3. The interface of claim 1, wherein the helium supply line comprises a splitter in fluid connection with a first branch for provision of helium to the first bypass flow controller and a second branch for provision of helium to the second bypass flow controller.

4. The interface of claim 3, wherein each of the first branch and second branch has a flow meter to maintain the same flow of helium in each said branch.

5. The interface of claim 4, wherein the flow meters are rotameters.

6. The interface of claim 5, further comprising a pressure gauge upstream of the splitter.

7. The interface of claim 1, further comprising a means for selectively heating the sample trap.

8. The interface of claim 1 wherein the sample trap contains carbon dioxide trapping material.

9. The interface of claim 1, wherein the sample contains a nitrogen oxide trapping material.

10. The interface of claim 1, comprising two or more sample traps fluidly connected in series.

11. A method of interfacing a TOC/TN analyzer with a mass spectrometer comprising the steps of:
a. providing a sample conduit having an inlet for fluid connection with a TOC/TN analyzer; and an outlet for fluid connection with a mass spectrometer;
b. fluidly connecting at least one sample trap within the sample conduit;
c. connecting a first sample flow controller in fluid connection between the TOC/TN analyzer and the sample trap, said flow controller being selectively positionable between an open position permitting flow into the sample trap while blocking helium flow to a first helium vent, and a closed position blocking flow to the sample trap, while permitting helium flow to inert the vent.
d. connecting a second sample flow controller in fluid connection between the sample trap and the mass spectrometer, said controller being selectively positionable between a closed position blocking flow to the mass spectrometer and permitting flow to an exhaust vent, and an open position blocking flow to the exhaust vent and permitting flow to the mass spectrometer;
e. Fluidly connecting an helium bypass conduit, having an inlet for fluid connection with an helium supply line, with an outlet in fluid connection with the sample conduit;
f. connecting a first bypass flow controller in fluid connection between the helium inlet and the sample conduit at a position downstream of the second sample flow controller, said first bypass flow controller being selectively positionable between a closed position blocking flow to the sample conduit, while permitting flow to an helium vent, and an open position permitting flow to the sample conduit, while blocking flow to the helium vent; and,
g. Installing a second bypass flow controller in fluid connection between the inlet of said helium bypass conduit and the sample conduit at a position upstream of the sample trap, said second bypass flow controller being selectively positionable between a closed position blocking flow to the sample conduit, and a second position permitting flow to the sample conduit; and,
h. Providing an electromechanical means for operating the first and second sample flow controllers and the first and second bypass flow controllers, operated through a software program executed by computer means.

12. A method of conveying a sample to an isotope detector for analysis comprising the steps of
a. collecting effluent containing the sample in a sample conduit containing a sample trap;
b. trapping the sample within the sample trap;
c. exhausting the remaining effluent; and,
d. releasing the sample from the sample trap into a helium stream flowing to the isotope detector.

13. The method of claim 12, further comprising the step of: flushing the sample trap with helium prior to step (d).

14. An interface to an isotope detector comprising:
a. a sample conduit having an inlet for fluid connection with a sample source; and an outlet for fluid connection with a mass spectrometer;
b. a sample trap fluidly connected in the sample conduit;
c. a first sample flow controller in fluid connection in the sample conduit between the sample source and the sample trap, said flow controller being selectively positionable between an open position permitting a sample flow into the sample trap while blocking the sample flow to a release vent, and a closed position blocking an effluent flow to the sample trap, while permitting the effluent flow to the release vent;
d. a second sample flow controller in fluid connection in the sample conduit between the sample trap and the mass spectrometer, said controller being selectively positionable between a closed position blocking sample flow to the mass spectrometer while permitting effluent flow to an exhaust vent, and a open position permitting sample flow to the mass spectrometer, while blocking effluent flow to the exhaust vent;
e. an helium bypass conduit having an inlet for fluid connection with an helium supply line and an outlet for fluid connection with the sample conduit at a position downstream of the second sample flow controller;
f. a first bypass flow controller in fluid connection between the helium bypass conduit and the sample conduit at a position downstream of the second sample flow controller; said first bypass flow controller being selectively positionable between an open position permitting helium flow into the sample conduit, while blocking helium flow to a first helium vent, and a closed position blocking helium flow into the sample conduit, while permitting helium flow to the first helium vent; and,
g. a second bypass flow controller in fluid connection between the helium bypass conduit and the sample conduit at a position upstream of the sample trap, said second bypass flow controller being selectively positionable between an open position permitting helium flow to the sample conduit, while blocking helium flow to a second helium flow vent, and a closed position blocking helium flow the sample conduit, while permitting helium flow to the second helium vent.

15. An analytical apparatus comprising:
a. a TOC/TN analyzer;
b. a isotope ratio mass spectrometer;
c. an interface comprising
i. a sample conduit having an inlet for fluid connection with a TOC/TN analyzer; and an outlet for fluid connection with a mass spectrometer;
ii. sample trap fluidly connected in the sample conduit;
iii. a first sample flow controller in fluid connection in the sample conduit between the TOC/TN analyzer and the sample trap, said flow controller being selectively positionable between an open position permitting a sample flow into the sample trap while blocking the sample flow to a release vent, and a closed position blocking an effluent flow to the sample trap, while permitting the effluent flow to the release vent;
iv. a second sample flow controller in fluid connection in the sample conduit between the sample trap and the mass spectrometer, said controller being selectively positionable between a closed position blocking sample flow to the mass spectrometer while permitting effluent flow to an exhaust vent, and a open position permitting sample flow to the mass spectrometer, while blocking effluent flow to the exhaust vent;
v. an helium bypass conduit having an inlet for fluid connection with an helium supply line and an outlet for fluid connection with the sample conduit at a position downstream of the second sample flow controller;
vi. a first bypass flow controller in fluid connection between the helium bypass conduit and the sample conduit at a position downstream of the second sample flow controller; said first bypass flow controller being selectively positionable between an open position permitting helium flow into the sample conduit, while blocking helium flow to a first helium vent, and a closed position blocking helium flow into the sample conduit, while permitting helium flow to the first helium vent; and,
vii. a second bypass flow controller in fluid connection between the helium bypass conduit and the sample conduit at a position upstream of the sample trap, said second bypass flow controller being selectively positionable between an open position permitting helium flow to the sample conduit, while blocking helium flow to a second helium flow vent, and a closed position blocking helium flow the sample conduit, while permitting helium flow to the second helium vent.
